(19) United States
(12) Patent Application Publication
(10) Pub. No.: US 2018/0147445 A1
(43) Pub. Date: May 31, 2018

(54) Exercise tracking system and method

(71) Applicant: Rayshard Le Beau Peters, Lemon Grove, CA (US)

(72) Inventor: Rayshard Le Beau Peters, Lemon Grove, CA (US)

(21) Appl. No.: 15/363,580

(22) Filed: Nov. 29, 2016

(51) Int. Cl. A63B 24/00; G09B 5/00

(52) U.S. Cl. CPC A63B 24/0006; A63B 24/0062; A63B 2024/0071; A63B 2024/0012; G09B 5/00

(57) ABSTRACT

A system for exercise tracking includes an exercise tracking device, including a processor, a non-transitory memory, an input/output, a machine controller, a motion controller, an energy controller that stores energy calculation and distribution tables; and a plurality of exercise machines, such that the exercise tracking device receives an identification signal from the machine identifier, in order to identify the exercise machine, and calculates aggregated energy expenditure per individual exercise machine and by muscle group. Also disclosed is a method for exercise tracking, including identifying machine, tracking motion, and calculating energy expenditure.

### CROSS-REFERENCE TO RELATED APPLICATIONS

N/A.

### FIELD OF THE INVENTION

The present invention relates generally to the field of devices and applications for use during fitness exercise, and more particularly to methods, devices, and systems for tracking a user during fitness exercise.

### BACKGROUND OF THE INVENTION

In recent years use of smartphones and smart watches have proliferated greatly. Many users want to keep track of their fitness goals and accomplishments while exercising in gyms.

There are apps which allow for tracking of calories spent, and other apps may be able to connect with exercise machines, but typically only when such machines are equipped with onboard processing capabilities, which adds to cost and complexity.

As such, considering the foregoing, it may be appreciated that there continues to be a need for novel and improved devices and methods for tracking a user during fitness exercise.

### SUMMARY OF THE INVENTION

The foregoing needs are met, to a great extent, by the present invention, wherein in aspects of this invention, enhancements are provided to the existing models of tracking a user during fitness exercise.

In an aspect, a system for exercise tracking can include:
a) an exercise tracking device; and
b) at least one exercise machine, including a machine identifier, which is an identifier that is attached to the exercise machine;
such that the exercise tracking device receives an identification signal from the machine identifier, in order to identify the exercise machine.

In related aspects, the machine identifier can be a
a) Radio frequency identification tag (RFID);
b) A bar code;
c) A near-field communication (NFC) tag;
d) A quick response (QR) code; or
e) A similar type of identification device.

In another related aspect, an exercise tracking device can include:
a) A processor;
b) A non-transitory memory;
c) An input/output;
d) A machine controller, which receives an identification signal in communication with a machine identifier, in order to identify the exercise machine, on which the machine identifier is attached;
e) A motion controller, which identifies motion of the exercise tracking device, such that the motion sensor records a sequence of repetitive motion patterns of the exercise tracking device, when a user is wearing the exercise tracking device during an exercise session on the exercise machine; and
f) An energy controller; all connected via
g) A data bus.

In yet a related aspect, the motion controller can be configured to store a set of prerecorded motion patterns, such that each prerecorded motion pattern corresponds to a particular exercise on a particular exercise machine.

In a related aspect, the motion controller can be configured to store aggregated exercise time spent per exercise machine, and for each exercise machine the time spent per exercise pattern on the machine; such that data is stored per session, and can be summarized for example per exercise session, per minute, per hour, per day, per week, per month, per year, etc.

In a related aspect, the energy controller can be configured to calculate aggregated energy expenditure, also called calorie burn, per exercise machine, and for each exercise machine the energy expended per exercise pattern on the machine; such that data is calculated during an exercise session, and can be summarized for example per exercise session, per minute, per hour, per day, per week, per month, per year, etc.

In a related aspect, the energy controller can be configured to store an energy calculation table, which for each exercise machine, exercise pattern, and applied weight, correlates energy expenditure per minute, and energy expenditure per completed motion pattern cycle, such that the energy controller can be configured to calculate aggregated energy expenditure by lookup in the energy calculation table.

In a related aspect, the energy controller can be configured to store an energy distribution table, which for each exercise machine and exercise pattern stores a set of muscle groups, such that each muscle group is associated with an energy percentage, such that the all energy percentages for the set of muscle groups accumulates to 100%, such that the energy controller can calculate energy expenditure by muscle based on the aggregated energy expenditure, by lookup in the energy distribution table.

In another aspect, a method for exercise tracking, can include:
a) identifying machine, wherein an exercising tracking device identifies a selected exercise machine in a plurality of exercise machines, by receiving an identification signal from a machine identifier, which is attached to the exercise machine;
b) tracking motion, wherein the exercising tracking device identifies motion of the exercise tracking device, such that the motion controller records a sequence of repetitive motion patterns of the exercise tracking device, when a user is wearing the exercise tracking device during an exercise session on the exercise machine;
c) calculating energy expenditure, wherein the exercising tracking device calculates an aggregated energy expenditure of the user, per individual exercise machine in the plurality of exercise machines, and for each individual exercise machine calculates the energy expended by the user per exercise pattern on the machine.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating a system for exercise tracking, according to an embodiment of the invention.

FIG. 2 is a schematic diagram illustrating an exercise tracking device, according to an embodiment of the invention.

FIG. 3 is a schematic diagram illustrating an exercise tracking server, according to an embodiment of the invention.

FIG. 4 is a flowchart illustrating steps that may be followed, in accordance with one embodiment of a method or process of exercise tracking.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

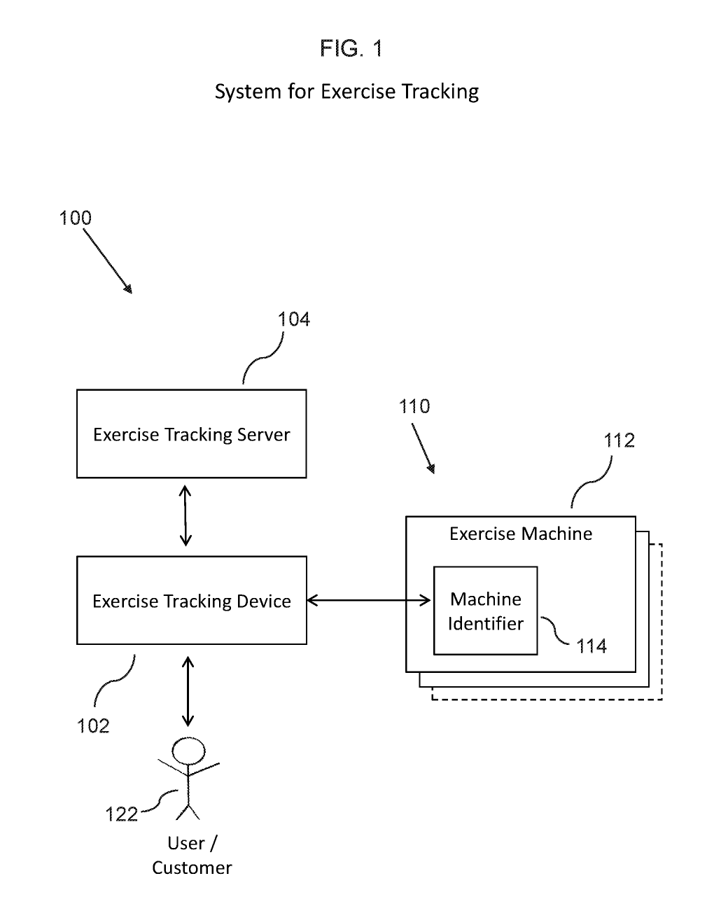

In the following, we describe the structure of an embodiment of a system for exercise tracking 100 with reference to FIG. 1, in such manner that like reference numerals refer to like components throughout; a convention that we shall employ for the remainder of this specification.

In an embodiment, a system for exercise tracking 100 can include:
a) an exercise tracking device 102; and
b) at least one exercise machine 112, including a machine identifier 114, which is an identifier that is attached to a surface of the exercise machine 112;
wherein the exercise tracking device 102 is configured to receive an identification signal from the machine identifier 114, in order to identify the exercise machine 112.

In related embodiments, the machine identifier 114 can be a
a) Radio frequency identification tag (RFID);
b) A bar code;
c) A near-field communication (NFC) tag;
d) A quick response (QR) code; or
e) A similar type of identification device.

In another related embodiment, the machine identifier 114 can be a QR code, wherein the exercise tracking device further comprises a camera 208, such that the exercise tracking device 102 can be configured to take a picture of the QR code and process the quick response code, in order to receive the identification signal.

In yet a related embodiment, the machine identifier 114 can be a near-field communication tag, such that the exercise tracking device 102 is configured to communicate with the near field communication tag in order to receive the identification signal.

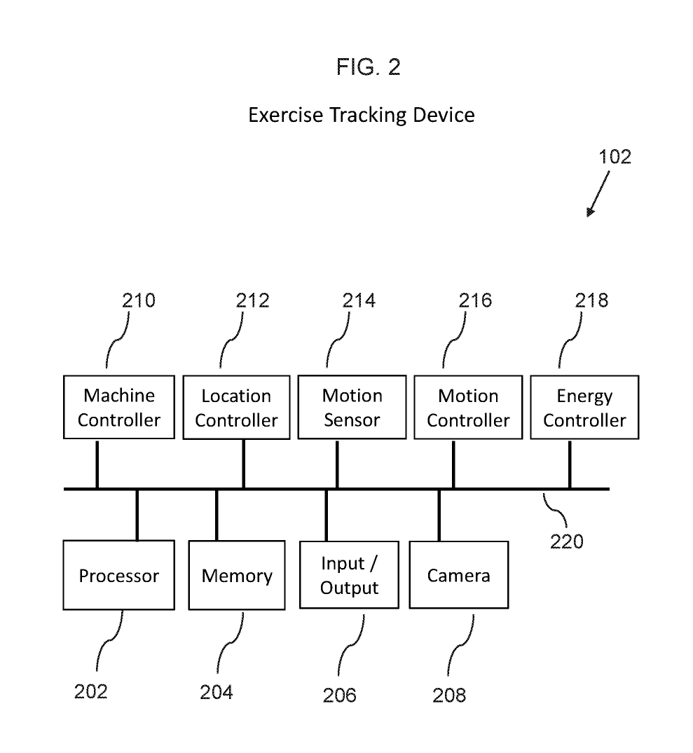

In a related embodiment, as shown in FIG. 2, an exercise tracking device 102 can comprise:
a) A processor 202;
b) A non-transitory memory 204;
c) An input/output 206;
d) A machine controller 210, which is configured to receive an identification signal in communication with a machine identifier 114, in order to identify the exercise machine 112, on which the machine identifier 114 is attached; and
e) A location controller 212, which is configured to identify a location of the exercise tracking device 102. The location controller 212 can use well-known available location services on the exercise tracking device 102, which can be based on use of GPS, radio triangulation, other well-known methods, and combinations of these. Such available location services can be based on use of Location API's, such as for example Google Location Services™, as available on Android Devices™; and
f) A motion controller 216, which is configured to identify motion of the exercise tracking device 102, such that the motion controller 216 is configured to record a current sequence of repetitive motion patterns of the exercise tracking device 102, when a user is wearing the exercise tracking device 102 during an exercise session on the exercise machine 112. The motion controller can use a motion sensor in the exercise tracking device 102, which for example can be of the well-known type of 3D accelerometers, also known as 3-axis accelerometers; all connected via
g) A data bus 220.

In a related embodiment, the machine controller 210 can be configured to obtain an applied weight for the fitness machine, based on user input from the user 122. The user input can be typed or from touch or voice input.

In a related embodiment, the motion controller 216 can be configured to store a set of prerecorded motion patterns, such that each prerecorded motion pattern corresponds to a particular exercise on a particular exercise machine 112, such that the motion controller is configured to determine a best match of a matched prerecorded motion pattern in the set of prerecorded motion patterns with the current sequence of repetitive motion, by use of a matching algorithm. The matching algorithm can for example be a least square matching to find the matched prerecorded motion pattern with the minimal sum of squared differences to the current sequence of repetitive motion. Alternatively, other well-known data/curve fitting/matching algorithms can be used, such as for example polynomial regression analysis.

In a related embodiment, the motion controller 216 can be configured to store aggregated exercise time spent per exercise machine, and for each exercise machine the time spent per exercise pattern on the machine; such that data is stored per session, and can be summarized for example per exercise session, per minute, per hour, per day, per week, per month, per year, etc.

In a related embodiment, the energy controller 218 can be configured to calculate aggregated energy expenditure, also called calorie burn, per exercise machine, and for each exercise machine the energy expended per exercise pattern on the machine; such that data is calculated during an exercise session, and can be summarized for example per exercise session, per minute, per hour, per day, per week, per month, per year, etc.

In a related embodiment, the energy controller 218 can be configured to store an energy calculation table, which for each exercise machine 112, exercise pattern, and applied weight, correlates energy expenditure per minute, and energy expenditure per completed motion pattern cycle, such that the energy controller 218 can be configured to calculate aggregated energy expenditure by lookup in the energy calculation table, using lookup parameters of exercise machine, exercise pattern, and applied weight and multiplying with the aggregated exercise time or the number of completed motion pattern cycles. Accordingly, the calculation of aggregated energy expenditure can be aggregated over a plurality of exercise machines 110.

In a related embodiment, the energy controller 218 can be configured to store an energy distribution table, which for each exercise machine 112 and exercise pattern stores a set of muscle groups, such that each muscle group is associated with an energy percentage, such that the all energy percentages for the set of muscle groups accumulates to 100%, such that the energy controller can calculate energy expenditure by muscle based on the aggregated energy expenditure, by lookup in the energy distribution table.

In related embodiments, the system for exercise tracking 100 can help users with their Fitness/weight loss goals, by tracking their progress on various machines and exercises. This information can also be shared with doctors, or personal trainers, or the community of users.

In a related embodiment, an exercise tracking server 104 can include:
a) a processor 302;
b) a non-transitory memory 304;
c) an input/output component 306;
d) A motion manager 316, which can be configured to perform all or part of the functions of the motion controller 216; and
e) An energy manager 318, which can be configured to perform all or part of the functions of the energy controller 218; all connected via
f) a data bus 320.

In related embodiments, the exercise tracking device 102 can include configurations as:
a) A mobile app, executing on a wearable mobile device, such as a smart watch;
b) A mobile app, executing on a mobile device, including a smart phone, such as for example an Android phone or iPhone;
c) A tablet app, executing on a tablet device, such as for example an Android or iOS tablet device;
d) A web application, executing in a Web browser;
e) A desktop application, executing on a personal computer, or similar device; or
f) An embedded application, executing on a processing device, such as for example a smart TV, a game console or other system.

It shall be understood that an executing instance of an embodiment of the system for exercise tracking 100, as shown in FIG. 1, can include a plurality 110 of exercise tracking devices 102, which are each tied to one or more users 122.

An executing instance of an embodiment of the system for exercise tracking 100, as shown in FIG. 1, can similarly include a plurality of exercise tracking servers 104.

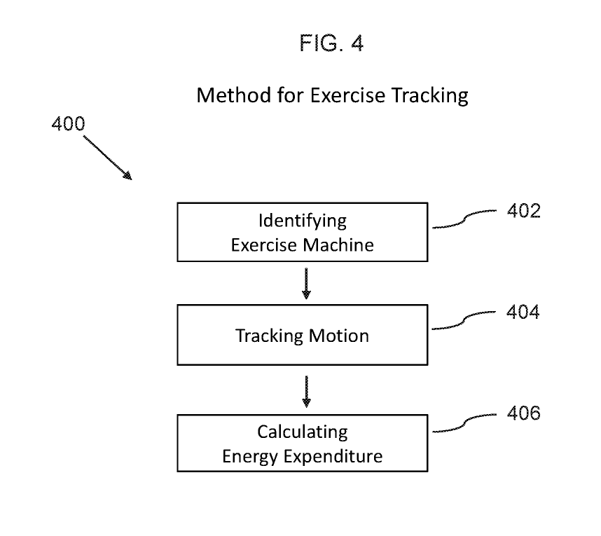

In an embodiment, as illustrated in FIG. 4, a method for exercise tracking 400, can include:
a) identifying exercise machine 402, wherein an exercising tracking device 102 identifies a selected exercise machine 112 in a plurality of exercise machines, by receiving an identification signal from a machine identifier 114, which is attached to the exercise machine 112;
b) tracking motion 404, wherein the exercising tracking device 102 identifies motion of the exercise tracking device, such that the motion controller records a sequence of repetitive motion patterns of the exercise tracking device, when a user is wearing the exercise tracking device during an exercise session on the exercise machine;
c) calculating energy expenditure 406, wherein the exercising tracking device 102 calculates an aggregated energy expenditure of the user, per individual exercise machine in the plurality of exercise machines, and for each individual exercise machine calculates the energy expended by the user per exercise pattern on the machine.

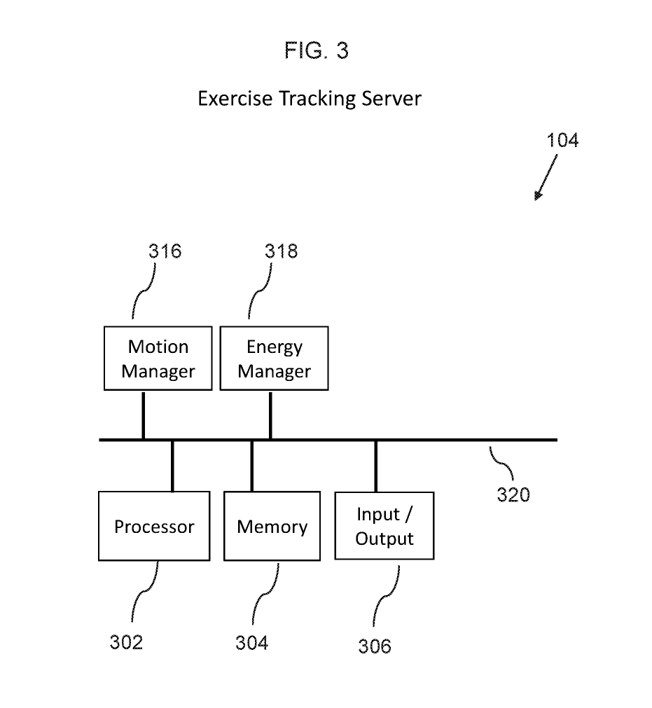

FIGS. 1, 2, 3 and 4 are block diagrams and flowcharts, methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 1, 2, and 3 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

FIG. 1 shows a depiction of an embodiment of the system for exercise tracking 100, including the exercise tracking device 102 and the exercise tracking server 104. In this relation, a server shall be understood to represent a general computing capability that can be physically manifested as one, two, or a plurality of individual physical computing devices, located at one or several physical locations. A server can for example be manifested as a shared computational use of one single desktop computer, a dedicated server, a cluster of rack-mounted physical servers, a datacenter, or network of datacenters, each such datacenter containing a plurality of physical servers, or a computing cloud, such as Amazon EC2 or Microsoft Azure.

It shall be understood that the above-mentioned components of the exercise tracking device 102 and the exercise tracking server 104 are to be interpreted in the most general manner.

For example, the processors 202 302 can each respectively include a single physical microprocessor or microcontroller, a cluster of processors, a datacenter or a cluster of datacenters, a computing cloud service, and the like.

In a further example, the non-transitory memory 204 and the non-transitory memory 304 can each respectively include various forms of non-transitory storage media, including random access memory and other forms of dynamic storage, and hard disks, hard disk clusters, cloud storage services, and other forms of long-term storage. Similarly, the input/output 206 and the input/output 306 can each respectively include a plurality of well-known input/output devices, such as screens, keyboards, pointing devices, motion trackers, communication ports, and so forth.

Furthermore, it shall be understood that the exercise tracking device 102 and the exercise tracking server 104 can each respectively include a number of other components that are well known in the art of general computer devices, and therefore shall not be further described herein. This can include system access to common functions and hardware, such as for example via operating system layers such as Windows, Linux, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In a related embodiment, the exercise tracking device 102 communicates with the exercise tracking server 104 over a network, which can include the general Internet, a Wide Area Network or a Local Area Network, or another form of communication network, transmitted on wired or wireless connections. Wireless networks can for example include Ethernet, Wi-Fi, Bluetooth, ZigBee, and NFC. The communication can be transferred via a secure, encrypted communication protocol.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

Here has thus been described a multitude of embodiments of the . . . device, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

For example, alternative embodiments can reconfigure or combine the components of the exercise tracking device 102 and the exercise tracking server 104. The components of the exercise tracking server 104 can be distributed over a plurality of physical, logical, or virtual servers. Parts or all of the components of the exercise tracking device 102 can be configured to operate in the exercise tracking server 104, whereby the exercise tracking device 102 for example can function as a thin client, performing only graphical user interface presentation and input/output functions. Alternatively, parts or all of the components of the exercise tracking server 104 can be configured to operate in the exercise tracking device 102.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A system for exercise tracking, comprising:
a) an exercise tracking device; and
b) at least one exercise machine, which comprises a machine identifier, which is attached to the exercise machine;
wherein the exercise tracking device is configured to receive an identification signal from the machine identifier, in order to identify the exercise machine.

2. The system for exercise tracking of claim 1, wherein the machine identifier is a quick response code, and wherein the exercise tracking device further comprises a camera, such that the exercise tracking device is configured to take a picture of the quick response code and process the quick response code, in order to receive the identification signal.

3. The system for exercise tracking of claim 1, wherein the machine identifier is a near-field communication tag, such that the exercise tracking device is configured to communicate with the near field communication tag in order to receive the identification signal.

4. The system for exercise tracking of claim 1, wherein the exercise tracking device further comprises:
a) a processor;
b) a non-transitory memory;
c) an input/output component; and
d) a machine controller, which is configured to receive the identification signal in communication with the machine identifier; all connected via
e) a data bus.

5. The system for exercise tracking of claim 4, wherein the exercise tracking device further comprises:
a motion sensor; and
a motion controller, which is configured to identify motion of the exercise tracking device, in communication with the motion sensor, such that the motion controller is configured to record a sequence of repetitive motion patterns of the exercise tracking device, when a user is wearing the exercise tracking device during an exercise session on the exercise machine.

6. The system for exercise tracking of claim 5, wherein the motion controller is configured to store a set of prerecorded motion patterns, such that each prerecorded motion pattern corresponds to a particular exercise on the at least one exercise machine, such that the motion controller is configured to determine a best match of a matched prerecorded motion pattern in the set of prerecorded motion patterns with the current sequence of repetitive motion, by use of a matching algorithm.

7. The system for exercise tracking of claim 6, wherein the matching algorithm is a least square matching algorithm, such that motion controller is configured to find the matched prerecorded motion pattern with the minimal sum of squared differences to the current sequence of repetitive motion.

8. The system for exercise tracking of claim 6, wherein the motion controller is configured to store aggregated exercise time spent per exercise machine, and for each exercise machine the time spent per exercise pattern on the machine.

9. The system for exercise tracking of claim 8, wherein the exercise tracking device further comprises:
an energy controller;
such that the energy controller is configured to calculate an aggregated energy expenditure per individual exercise machine in the at least one exercise machine, and for each individual exercise machine is configured to calculate the energy expended per exercise pattern on the individual exercise machine.

10. The system for exercise tracking of claim 9, wherein the energy controller is configured to store an energy calculation table, which for each exercise machine, exercise pattern, and applied weight, correlates energy expenditure per minute, and energy expenditure per completed motion pattern cycle, such that the energy controller is configured to calculate the aggregated energy expenditure per individual exercise machine by lookup in the energy calculation table.

11. The system for exercise tracking of claim 10, wherein the energy controller is configured to store an energy distribution table, which for each exercise machine and exercise pattern stores a set of muscle group identifiers, such that each muscle group identifier is associated with an energy percentage, such that the energy controller calculates energy expenditure by muscle group based on the aggregated energy expenditure, by lookup in the energy distribution table.

12. A method for exercise tracking, comprising:
a) identifying machine, wherein an exercising tracking device identifies an exercise machine in a plurality of exercise machines, by receiving an identification signal from a machine identifier, which is attached to the exercise machine;
b) tracking motion, wherein the exercising tracking device identifies motion of the exercise tracking device, such that the exercising tracking device records a sequence of repetitive motion patterns of the exercise tracking device, when a user is wearing the exercise tracking device during an exercise session on the exercise machine; and
c) calculating energy expenditure, wherein the exercising tracking device calculates an aggregated energy expenditure of the user, per individual exercise machine in the plurality of exercise machines, and for each individual exercise machine calculates the energy expended by the user per exercise pattern on the machine.

13. The method for exercise tracking of claim 12, wherein the machine identifier is a quick response code, and wherein the exercise tracking device further comprises a camera, such that the exercise tracking device is configured to take a picture of the quick response code and process the quick response code, in order to receive the identification signal.

14. The method for exercise tracking of claim 12, wherein the machine identifier is a near-field communication tag, such that the exercise tracking device is configured to communicate with the near field communication tag in order to receive the identification signal.

15. The method for exercise tracking of claim 12, wherein the exercise tracking device identifies motion of the exercise tracking device, by using a motion sensor, such that the exercise tracking device records a sequence of repetitive motion patterns of the exercise tracking device, when a user is wearing the exercise tracking device during an exercise session on the exercise machine.

16. The method for exercise tracking of claim 15, wherein the exercise tracking device determines a best match of a matched prerecorded motion pattern in a set of prerecorded motion patterns with the current sequence of repetitive motion, by use of a matching algorithm.

17. The method for exercise tracking of claim 16, wherein the exercise tracking device stores aggregated exercise time spent per exercise machine, and for each exercise machine the time spent per exercise pattern on the machine.

18. The method for exercise tracking of claim 17, wherein the exercise tracking device calculates an aggregated energy expenditure per individual exercise machine in the at least one exercise machine, and for each individual exercise machine calculates the energy expended per exercise pattern on the individual exercise machine.

19. The method for exercise tracking of claim 18, wherein the exercise tracking device stores an energy calculation table, which for each exercise machine, exercise pattern, and applied weight, correlates energy expenditure per minute, and energy expenditure per completed motion pattern cycle, such that the energy controller is configured to calculate the aggregated energy expenditure per individual exercise machine by lookup in the energy calculation table.

20. The method for exercise tracking of claim 19, wherein the exercise tracking device is configured to store an energy distribution table, which for each exercise machine and exercise pattern stores a set of muscle group identifiers, such that each muscle group identifier is associated with an energy percentage, such that the energy controller calculates energy expenditure by muscle group based on the aggregated energy expenditure, by lookup in the energy distribution table.
